(19) United States
(12) Patent Application Publication
(10) Pub. No.: US 2007/0055492 A1
(43) Pub. Date: Mar. 8, 2007

(54) Configurable grammar templates

(75) Inventors: Ye-Yi Wang, Redmond, WA (US); Dong Yu, Kirkland, WA (US); Yun-Cheng Ju, Bellevue, WA (US); Alejandro Acero, Bellevue, WA (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/259,475

(22) Filed: Oct. 26, 2005

Related U.S. Application Data
(60) Provisional application No. 60/714,107, filed on Sep. 2, 2005.

(51) Int. Cl. G06F 17/27

(52) U.S. Cl. 704/9

(57) ABSTRACT

To provide application developers with the ability to easily form customized grammars, grammar extensions are provided that allow application developers to selectively include portions of grammar templates and to easily combine grammar elements to form new grammar structures.

### REFERENCE TO RELATED APPLICATIONS

The present application claims priority benefit to provisional application 60/714,107 filed on Sep. 2, 2005 and entitled BASIC GRAMMAR CONTROLS.

### BACKGROUND

Speech recognition systems utilize grammars to define allowed word sequences and to associate semantic tags with particular word sequences. Typically, such grammars are written according to a specification, such as the W3C Speech Recognition Grammar Specification (SRGS).

For application developers, authoring speech recognition grammars has proven to be quite difficult. To assist application developers, grammar libraries have been written that consist of specialized grammars that developers can selectively include in their application. Unfortunately, such library grammars must be written so that they recognize a large number of word sequences. This overgeneralization of the grammar increases the error rate in speech recognition, since the grammar tends to allow recognition of word sequences that the application developer never intended.

The discussion above is merely provided for general background information and is not intended to be used as an aid in determining the scope of the claimed subject matter.

### SUMMARY

To provide application developers with the ability to easily form customized grammars, grammar extensions are provided that allow application developers to selectively include customized instances of grammar templates and to easily combine grammar elements to form new grammar templates.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram of one computing environment in which some embodiments may be practiced.

FIG. 2 is a block diagram of an alternative computing environment in which some embodiments may be practiced.

FIG. 3 is a block diagram of elements used to form a grammar under one embodiment.

FIG. 4 is a flow diagram of a method of compiling a grammar with extensions into a grammar without extensions.

FIG. 5 is a flow diagram of a method of compiling a template reference extension.

FIG. 6 is a flow diagram of a method of compiling a paste extension.

FIG. 7 is a flow diagram of a method of compiling a normalized extension.

### DETAILED DESCRIPTION

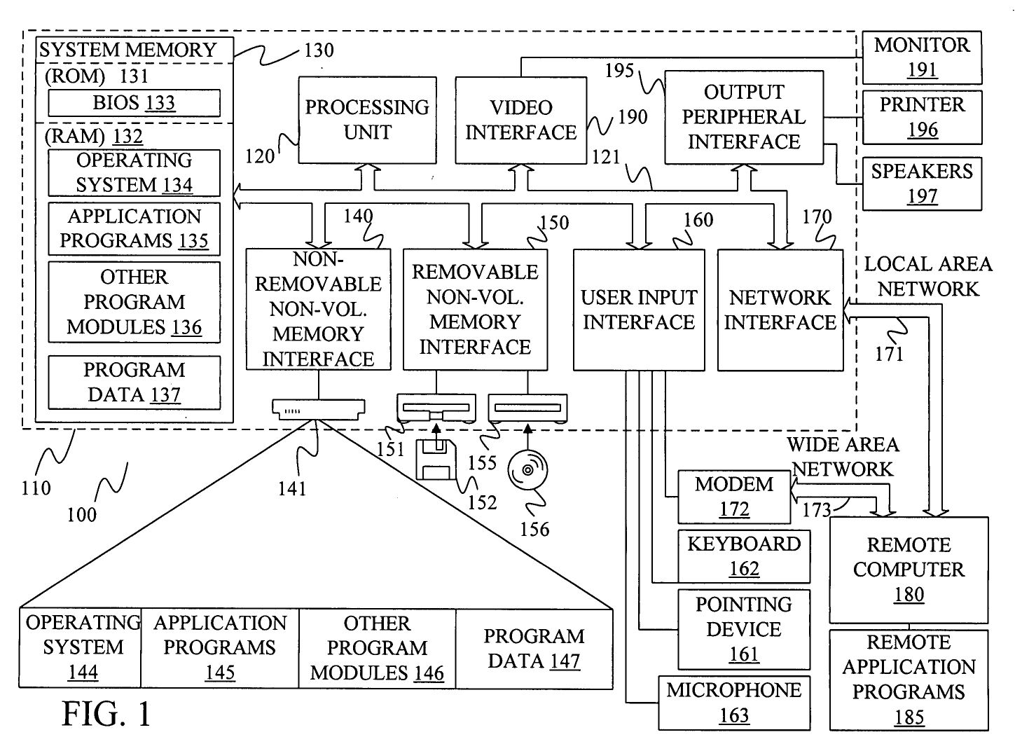

FIG. 1 illustrates an example of a suitable computing system environment 100 on which embodiments may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

Embodiments are operational with numerous other general purpose or special purpose computing system environments or configurations. Examples of well-known computing systems, environments, and/or configurations that may be suitable for use with various embodiments include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

Embodiments may be described in the general context of computer-executable instructions, such as program modules, being executed by a computer. Generally, program modules include routines, programs, objects, components, data structures, etc. that perform particular tasks or implement particular abstract data types. Some embodiments are designed to be practiced in distributed computing environments where tasks are performed by remote processing devices that are linked through a communications network. In a distributed computing environment, program modules are located in both local and remote computer storage media including memory storage devices.

With reference to FIG. 1, an exemplary system for implementing some embodiments includes a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120′. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing-device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 is operated in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

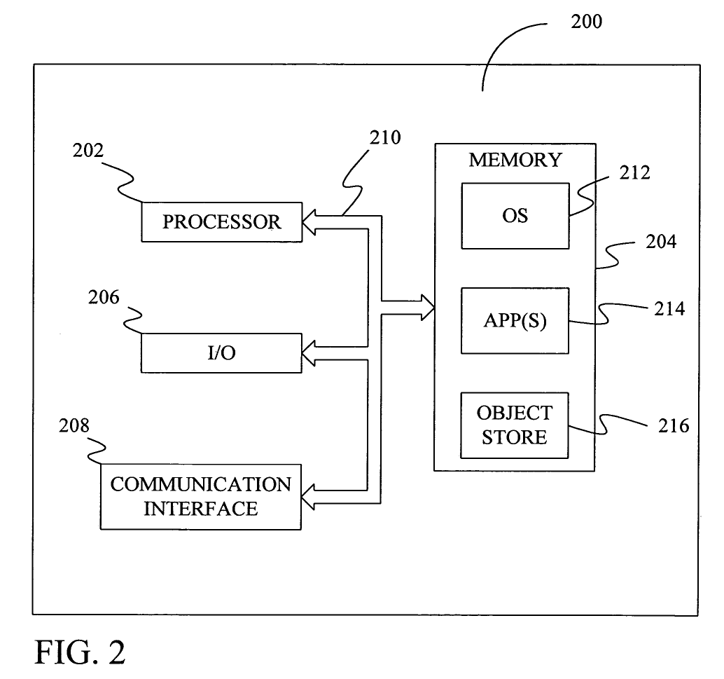

FIG. 2 is a block diagram of a mobile device 200, which is an exemplary computing environment. Mobile device 200 includes a microprocessor 202, memory 204, input/output (I/O) components 206, and a communication interface 208 for communicating with remote computers or other mobile devices. In one embodiment, the afore-mentioned components are coupled for communication with one another over a suitable bus 210.

Memory 204 is implemented as non-volatile electronic memory such as random access memory (RAM) with a battery back-up module (not shown) such that information stored in memory 204 is not lost when the general power to mobile device 200 is shut down. A portion of memory 204 is preferably allocated as addressable memory for program execution, while another portion of memory 204 is preferably used for storage, such as to simulate storage on a disk drive.

Memory 204 includes an operating system 212, application programs 214 as well as an object store 216. During operation, operating system 212 is preferably executed by processor 202 from memory 204. Operating system 212, in one preferred embodiment, is a WINDOWS® CE brand operating system commercially available from Microsoft Corporation. Operating system 212 is preferably designed for mobile devices, and implements database features that can be utilized by applications 214 through a set of exposed application programming interfaces and methods. The objects in object store 216 are maintained by applications 214 and operating system 212, at least partially in response to calls to the exposed application programming interfaces and methods.

Communication interface 208 represents numerous devices and technologies that allow mobile device 200 to send and receive information. The devices include wired and wireless modems, satellite receivers and broadcast tuners to name a few. Mobile device 200 can also be directly connected to a computer to exchange data therewith. In such cases, communication interface 208 can be an infrared transceiver or a serial or parallel communication connection, all of which are capable of transmitting streaming information.

Input/output components 206 include a variety of input devices such as a touch-sensitive screen, buttons, rollers, and a microphone as well as a variety of output devices including an audio generator, a vibrating device, and a display. The devices listed above are by way of example and need not all be present on mobile device 200. In addition, other input/output devices may be attached to or found with mobile device 200.

To provide application developers with the ability to easily form customized grammars, extensions to the W3C SRGS are provided. These extensions allow application developers to selectively include portions of grammar templates and to easily combine grammar elements to form new grammar structures.

### Template/Templateref

Under one embodiment, two extensions added to the SRGS are the <template> and <templateref> tags. The <template> tags are used to delimit grammar structures that are placed into a grammar when the template is referenced using a <templateref> tag. Each <templateref> refers to a template using the uniform resource identifier for the template. For templates defined in the same grammar as the <templateref>, the uniform resource identifier is the name of the template preceded by the pound symbol (#). For example, the grammar instructions:

<templateref uri=“#yesno”>
<paramater name=“core” value=“true”/>
</templateref>

refer to a template named “yesno” that is defined within the same grammar. For templates that are defined outside of the current grammar, the uniform resource identifier provides the path to the template, which may be located on a local machine or on a remote server.

As shown above, <templateref> tags may delimit one or more <Parameter> tags that provide values for parameters used by the template. Under some embodiments, if there is more than one parameter, the parameter tags are delimited by a pair of <Parameters> tags. These parameter values are used to determine how the grammar template is to be customized in the output grammar.

The <template> tags include a “name” property and in some embodiments a “scope” property that defines whether the template may be accessed by other grammars. Each parameter in the template is provided in a <parameter> tag together with the “type” for the parameter and the “default” value for the parameter. For example:

```
<template name=“yesno” scope=“public”>
  <paramater name=“core” type=“bool” default=“true”/>
  <one-of>
    <item>yes<tag>$=1</tag></item>
    <item>no<tag>$=0</tag></item>
    <item cond=“! parameter/@core”>I think so
        <tag>$=1</tag>
    </item>
    <item cond=“! parameter/@core”>I don't think so
        <tag>$=0</tag>
    </item>
  </one-of>
</template>
```

Items within the template may include the “cond” property. When the “cond” property is defined for an item, the appearance of the item in the output grammar becomes conditioned on the value of the “cond” property. In one particular embodiment, if the “cond” property has a value of true, the item is included in the output grammar. If the “cond” value is false, the item is not included in the output grammar. Typically, the value of the “cond” property will be based on one or more parameters set in the <templateref> tags that refer to the template. The parameters are referenced in the “cond” expression as parameter/@[parametername]. (for example parameter/@core above). By setting the values for the parameters in the <templateref> tags, developers are able to customize the output grammar formed from a template. This allows different grammar structures to be formed from the same template.

For example, in the <templateref> tags above, the <parameter> tag sets the parameter CORE to a value of TRUE. This parameter value is then used to determine whether “I think so” and “I don't think so” will be included in the output grammar. Because CORE has a value of true, “! parameter/@core” evaluates to false (The “!” indicates inverse). Thus, the grammar instructions above would result in the following grammar structure being included in the output grammar:

```
<one-of>
    <item>yes<tag>$=1</tag></item>
    <item>no<tag>$=0</tag></item>
</one-of>
```

However, if the parameter values are set to false in the <templateref> tags, as in:

<templateref uri=“#yesno”>
<paramater name=“core” value=“false”/>
</templateref>

the following grammar structure would be produced:

```
<one-of>
    <item>yes<tag>$=1</tag></item>
    <item>no<tag>$=0</tag></item>
    <item>I think so<tag>$=1</tag></item>
    <item>I don't think so<tag>$=0</tag></item>
</one-of>
```

Thus, although the two <templateref> tags above refer to the same “yesno” template, two different SRGS grammars are formed because the templateref tags set the parameter “core” to different values.

When a template is included in a grammar, the structures defined within the template are only produced in the output grammar if there is at least one reference to the template. Thus, if no <templateref> tags refer to a template in the grammar, the structures of the template will not be included in the output grammar.

A template definition may include an embedded <templateref> tag, thus allowing one template to rely on another template. As discussed further below, when a <templateref> tag is found in a template definition, the output grammar is formed by recursively expanding the grammar structure based on each nested template.

Under some embodiments, a set of standard templates are provided that do not need to be defined within a grammar. These standard templates include an alphanumeric template, which takes a regular expression as its input parameter and produces a grammar structure optimized for recognizing that regular expression. A regular expression consists of one or multiple alternates (branches), where alternates are delimited by “|”. Each branch consists of a sequence of pieces. Each piece is an atom that is optionally quantified. The quantifier specifies the repetition of the atom. It can be a number (e.g. {3}), a number range (e.g. {0-3}) or a reserved character (e.g. ‘+’ for more than once, or ‘*’ for zero or more times). The atom can be a character, a character class (e.g. [A-Z] for all uppercase letters, or \d for the ten digits [0-9]), or recursively a parenthesized regular expression.

The basic templates also include cardinal number templates that take either an input number range or a number set as parameters and provide a limited grammar structure capable of recognizing cardinal representations of the numbers in the range or the set. Another standard template is an ordinal number template that can be provided with a range of numbers or a set of numbers as its parameters. This template returns a grammar structure capable of recognizing ordinal representations of the numbers in the range or the set. Note that for the cardinal number and the ordinal number templates, numbers outside of the range or set will not be included in the grammar structure. As a result, fewer speech recognition errors will take place.

The last basic template is a list template that is capable of generating a grammar structure that can recognize words in a list or a database column as alternatives for each other. For example, if a template reference to the list template is provided with a list (apple, pear, orange, peach) as its parameter values, the template grammar compiler will take this templateref as input and generate the following SRGS grammar segment:

```
<one-of>
    <item> apple </item>
    <item> pear </item>
    <item> orange </item>
    <item> peach </item>
</one-of>
```

If the list template is provided with the location of a column in a table of a database on a database server, the template will provide a similar structure as above with a separate item for each row in the column.

Under one embodiment, the parameter in the <templateref> to the alphanumeric template can consist of a template reference to a list template. When this occurs, the alphanumeric template returns a spelling grammar structure that is capable of recognizing the spelling of each entry in the list. Thus, the alphanumeric and the list templates can be used to form a composition where the output from the list template is used as an input parameter to the alphanumeric template. For example

```
<templateref name=“alphanumeric”>
  <parameter name=”exp” >
    <templateref name=“list”>
      <parameter name=”source”
        value=“server:db:city:cityname”/>
    </templateref>
  </parameter>
</templateref>
```

where the input parameter named “exp” for the <templateref> that refers to the alphanumeric template has a value slot that is filled with a <templateref> to a list template. The reference to the list template produces a grammar structure consisting of <one-of> tags that delimit a set of item tags, with each city in the database column “Cityname” occurring in separate item tags. Because this template reference is found in the value slot for the exp parameter, the alphanumeric template compiler algorithmically creates the rules that accept the different utterances that spell out the city names, like “S e a t t l e” or “S e a double t l e,” and places them between the item tags for each city entry. In addition, the template grammar compiler places the city name within semantic tags, and associates the semantic tags with the corresponding item rules in the spelling grammar. For example, for the city name Seattle, the alphanumeric template would place “Seattle” in semantic tags and would associate it with the grammar rules that accept “S e a t t l e” or “S e a double t l e.” The template grammar compiler also properly prefixes the rules, such that a user utterance, for example, “S e a double t l e,” will initially result in a single recognition hypothesis containing the prefix string “Sea” instead of multiple hypotheses with the same prefix, each corresponds to a rule start with that prefix. This prefixing mechanism will greatly improve the speed of the speech recognizer.

### Paste Tags

Under some embodiments, paste operations are supported, which perform a pair-wise concatenation of entries in two lists. For example, given a list of first names (Joe, Bill, Mary) and a list of last names (Smith, Jones, Adams) the paste operation will produce a list of (Joe Smith, Bill Jones, Mary Adams).

Under one embodiment, the paste operation is indicated by delimiting two lists within paste tags. For example:

```
<paste>
  <item>
    <templateref name=“list”>
      <parameter name=”source”
          value=“server:db:city:cityname/>
    </templateref>
  </item>
  <item>
    <templateref name=“list”>
      <parameter name=”source”
          value=“server:db:city:statename/>
    </templateref>
  <item>
  </paste>
```

In this grammar structure, there are two references to the list template that are delimited by the <paste> tags. The first templateref produces a grammar structure for a list of city names. The second templateref produces a grammar structure for a list of state names. Before the paste operation is performed, the templateref tags are resolved to produce the grammar structures representing the respective lists. For example, the first templateref would produce a grammar structure such as:

```
<one-of>
    <item>Seattle</item>
    <item>Los Angeles</item>
    <item>Miami</item>
</one-of>
```

and the second templateref would produce a grammar structure such as:

```
<one-of>
    <item>Washington</item>
    <item>California</item>
    <item>Florida</item>
</one-of>
```

The paste operation then combines these two lists to produce a structure in the output grammar of:

```
<one-of>
  <item>Seattle Washington</item>
  <item>Los Angeles California</item>
  <item>Miami Florida</item>
</one-of>
```

### Normalization Tags

Under some embodiments, an extension to the SRGS grammar is provided to support a normalization operation. In a normalization operation, a list of words are set as semantic values for another list of words that are to be recognized. For example, the list of words to be recognized could include city names and the normalization operation could be used to set the semantic values for those city names to be the city codes found in a list of city codes.

Under some embodiments, the normalization operation is indicated in a grammar by delimiting two lists within <normalize> tags. For example:

```
<normalize>
  <item>
    <templateref name=“list”>
      <parameter name=”source”
        value=“server:db:city:cityname” />
    </templateref>
  </item>
  <item>
    <templateref name=“list”>
      <parameter name=”source”
        value=“server:db:city:citycode” />
    </templateref>
  </item>
</normalize>
```

In the example above, the <normalize> tags delimit two lists. The first list, formed by referring to the list template and setting the “source” parameter to a column of city names in a database, provides a list of words to be recognized. The second list, formed by referring to the list template and setting the “source” parameter to a column of city codes in the database, provides a list of semantic values to be returned.

In forming a grammar structure, the normalization extension first resolves the lists that are delimited between the <normalize> tags. For the example above, this would produce grammar structures such as:

```
  <one-of>
    <item>Seattle</item>
    <item>Minneapolis</item>
    <item>Boston</item>
  <one-of>
and
  <one-of>
    <item>SEA</item>
    <item>MSP</item>
    <item>BOS</item>
  <one-of>
```

The normalization operation then combines the lists by forming a list that is similar to the first list but with the addition of the items in the second list placed between <tag> semantic tags. Thus, after the normalization, the output grammar structure of the example above would be:

```
<one-of>
  <item>Seattle<tag>$=SEA</tag></item>
  <item>Minneapolis<tag>$=MSP</tag></item>
  <item>Boston<tag>$=BOS</tag></item>
<one-of>
```

### Compiling Grammars with Template Extensions

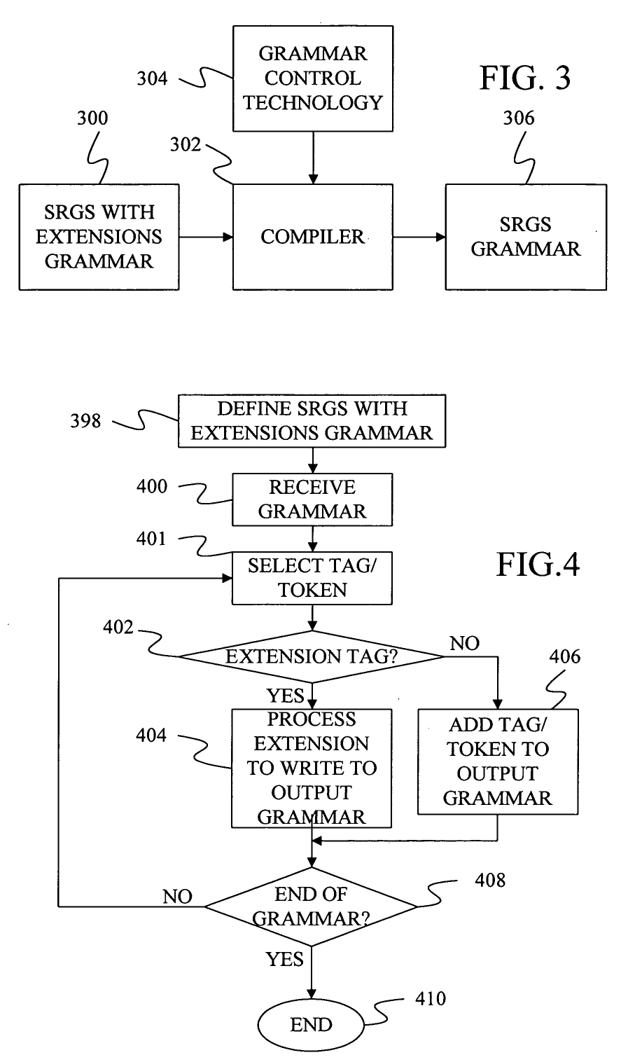

FIG. 3 provides a block diagram of elements used to form an SRGS grammar from an SRGS with extensions grammar. Specifically, in FIG. 3, SRGS with extensions grammar 300 is provided to a compiler 302, which uses grammar control technology 304 to form a compiled or output grammar 306, which in one embodiment conforms to the SRGS specification. Grammar control technology 304 includes instructions for performing the composition, paste, and normalization operations described above as well as for resolving templateref tags. In addition, grammar control technology 304 includes instructions for the alphabetic, cardinal, ordinal, and list templates.

SRGS with template extensions grammar 300 can include extensions such as templateref, template, template composition, paste, normalize, as well as references to the alphabetic, cardinal, ordinal, and list templates. SRGS grammar 306 does not include references to these extensions.

FIG. 4 provides a flow diagram of a method used to form SRGS grammar 306.

The SRGS with extensions grammar 300 is defined at step 398. This involves writing a grammar that includes at least one extension such as templateref, template, paste or normalize. At step 400, the SRGS with extensions grammar 300 is received by compiler 302. A tag or token in SRGS with extensions grammar 300 is then selected at step 401 by compiler 302. At step 402, the tag or token is examined to determine if it is an extension tag such as <templateref>, <template>, <paste> or <normalization>. If it is an extension tag, the extension tag is processed at step 404 as discussed further below. If the tag or token is not an extension tag, the tag or token is written to an output grammar at step 406. After steps 404 and 406, the compiler checks to see if it has reached the end of the grammar at step 408. If it has not reached the end of the grammar, the next token or tag is selected by returning to step 404. If it has reached the end of the grammar, the output grammar represents output SRGS 306 and the process ends at step 410.

In FIG. 4, when <template> extension tags are encountered at step 402, they are processed at step 404 by not writing any of the grammar structure between the <template> tags to the output grammar. Only instantiated templates are compiled and included in the output grammar. In other words, grammar structures defined within <template> tags are only written to the output grammar if the template is referenced by <templateref> tags. In some embodiments, the grammar structure (rules) defined in the <template> tags is stored so that the contents of the template can be easily accessed when a <templateref> is found that refers to the template. In some embodiments, the grammar structure (rules) can be algorithmically created according to the template that has been referenced and its parameter values.

In step 404, when other extension tags are processed, the processing typically results in a grammar structure being written to the output grammar in the position of the extension tag. This grammar structure does not include any extension tags.

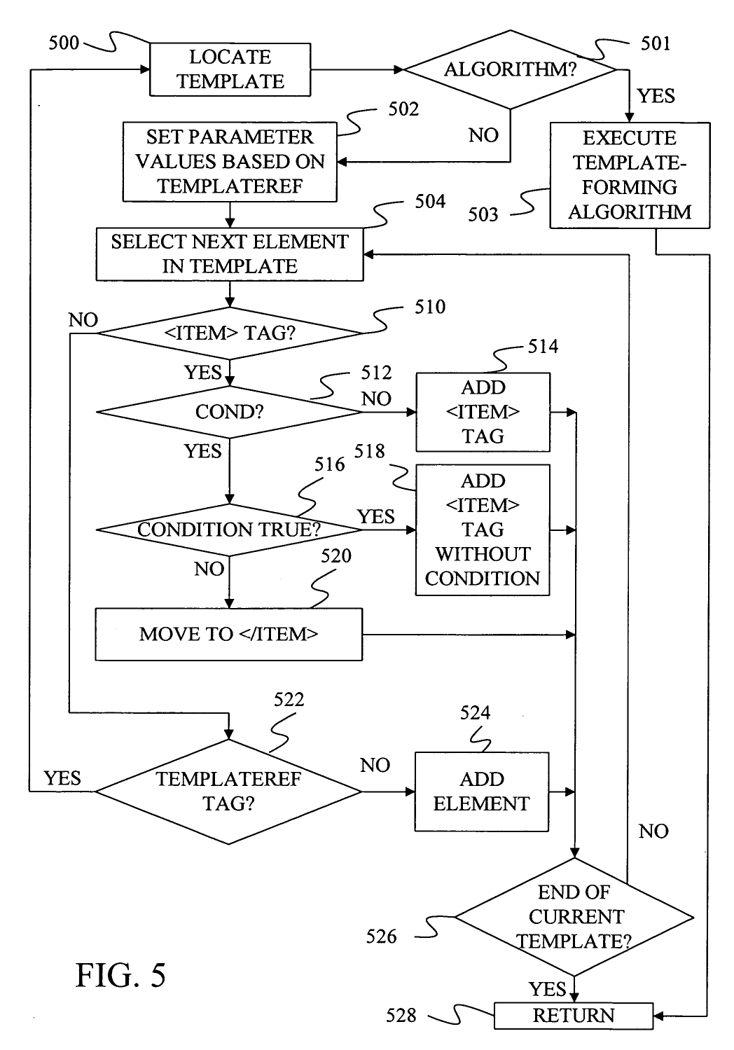

FIG. 5 provides a flow diagram of a method of processing a <templateref> extension tag at step 404. At step 500 of FIG. 5, the template referenced by the templateref is located. The template may be located within the SRGS with extensions grammar 300 or may be located in a repository of templates located on a server or in a local machine. In addition, the template may be implemented algorithmically by the compiler, such as for the Alphanumeric, Ordinal, Cardinal and List templates discussed above.

At step 501, the compiler determines if the template is to be implemented algorithmically by the compiler. If it is to be implemented algorithmically, the algorithm is executed at step 503 and the grammar template generated by the algorithm is stored. In order to implement the template, the algorithm first resolves the parameters delimited in the templateref if necessary. For example, if the templateref includes an embedded templateref, the algorithm resolves the embedded templateref first to provide the parameters used in the outer templateref. Once the compiler has placed the generated grammar template into the output grammar, the process returns at step 528.

If the template is not implemented algorithmically at step 501, the process continues at step 502, where the parameters in the located template are set based on the parameter values found in the templateref. If the parameters' values are not set in the templateref, default values for the parameters, which are set in the template, are used.

At step 504, the next element in the template is selected. At step 510 the selected element is examined to determine if it is an <item> tag. If it is an <item> tag, the tag is examined to determine if it has a “cond” property at step 512. If it does not have a “cond” property at step 512, the <item> tag is added at step 514 to the output grammar. If the <item> tag does have a “cond” property, the “cond” property is evaluated to determine if it is true or false at step 516. If the “cond” property is true at step 516, the <item> tag without the “cond” property is written to the output grammar at step 518. If the “cond” property of the <item> tag is not true at step 516, the process moves to the corresponding </item> tag at step 518. This prevents the contents of the <item> tag from being written to the output grammar.

If the element is not an <item> tag at step 510, the element is examined at step 522 to determine if it is a <templateref> tag. If it is not a <templateref> tag, the element is added to the output grammar at step 524. If it is a <templateref> tag, the process returns to step 500 to locate the template for this <templateref> tag. Thus, as shown in FIG. 5, the grammar structure within a template may reference another template by using an embedded <templateref>. This causes a recursion in the production of the output grammar as indicated by the return to step 500.

After steps 514, 518, 520 and 524, the process moves to step 526 to determine if the end of the current template has been reached. If the end of the template has not been reached, the process returns to step 504 and the next element in the template is selected. If the end of the current template has been reached at step 526, the process returns at step 528. When the process has recursively moved through an embedded templateref within a template, this return step involves returning to the processing of the parent template. When the current template is the upper-most template, this return step returns processing to step 408 of FIG. 4.

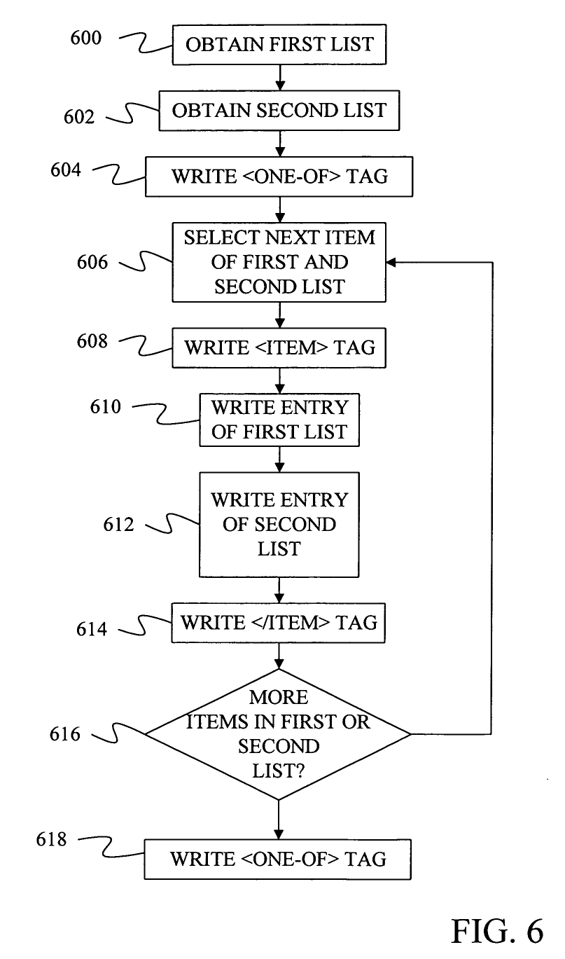

FIG. 6 provides a flow diagram of a method of processing the <paste> extension tag during step 404. In steps 600 and 602 of FIG. 6, the first and second lists used by the <paste> tag are obtained. These lists may be written into the grammar directly using the <one-of> tags and a set of <item> tags with each item representing a separate entry in the list. Alternatively, the list may be designated in the grammar using a <templateref> extension that refers to the list template. If a <templateref> extension is used to designate the list, obtaining the list in step 600 or 602 involves obtaining the list from the list template so that the list is described using the <one-of> tags and a set of <item> tags.

At step 604, a <one-of> tag is written to the output grammar. At step 606, the next items of the first and second lists are selected. During the first pass through the method, the first item in each list is selected at step 606. At step 608, an <item> tag is written to the output grammar and at step 610, the entry between the <item> tags of the selected item of the first list is written to the output grammar. At step 612, the entry between the <item> tags of the item selected from the second list is written to the output grammar. At step 614, a </item> tag is written to the output grammar.

At step 616, the method determines if there are more items in the first or second list. If there are more items, the process returns to step 606 to select the next item from each list. Steps 606 through 614 are repeated until there are no more items in the first and second list. When that occurs, the process continues at step 618 where a </one-of> tag is written to the output grammar.

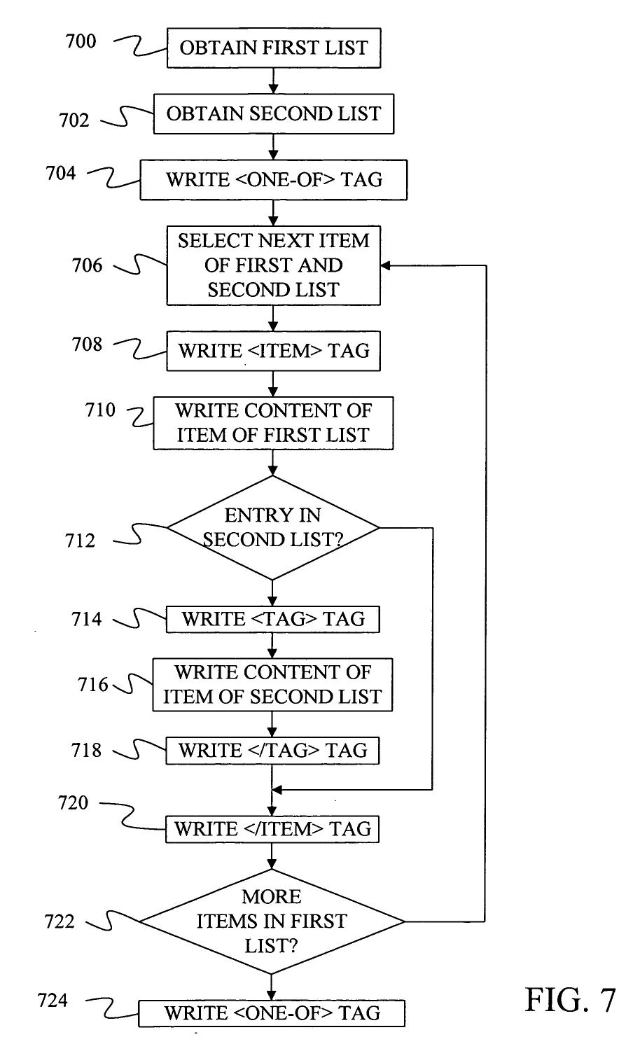

FIG. 7 provides a flow diagram for processing a <normalize> extension tag during step 404 of FIG. 4. In steps 700 and 702, a first and second list designated between the <normalize> tags are obtained. Obtaining these lists is similar to obtaining the lists in step 600 and 602 of FIG. 6. At step 704, a <one-of> tag is written to the output grammar and at step 706 an item is selected from the first and second list.

At step 708, an <item> tag is written to the output grammar followed by the content between the <item> tags of the item selected from the first list. At step 712, the process determines if there is an item in the second list. If there is an item, a <tag> tag is written to the output grammar at step 714 followed by the content between the <item> tags of the item in the second list at step 716. At step 718 a </tag> tag is written to the output grammar.

After step 718, or if there are not items in the second list at step 712, a </item> tag is written to the output grammar at step 720. At step 722, the process determines if there are more items in the first list. If there are more items, the next items in the first and second list are selected at step 706 and steps 708 through 720 are repeated. When there are no more items in the first list, the process of FIG. 7 ends by writing a </one-of> tag at step 724. Processing then returns to step 408 of FIG. 4.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
receiving a grammar that comprises a reference to a template and a parameter value used by the template; and
compiling the grammar by utilizing the template and the parameter value to determine what grammar elements to include in a compiled grammar.

2. The method of claim 1 further comprising positioning the grammar elements in the compiled grammar based on the position of the reference to the template in the grammar.

3. The method of claim 1 wherein the parameter value is associated with the reference to the template.

4. The method of claim 1 wherein the grammar further comprises a second reference to the template and a second parameter value associated with the second reference, the second parameter value being different than the parameter value.

5. The method of claim 5 wherein compiling the grammar comprises inserting a first set of grammar elements from the template based on the reference to the template and the parameter value and inserting a second set of grammar elements from the template based on the second reference to the template and the second parameter value, the second set of grammar elements being different from the first set of grammar elements.

6. The method of claim 1 wherein the template is defined within the grammar.

7. The method of claim 1 wherein compiling the grammar comprises accessing a remote computing device to retrieve the template.

8. The method of claim 1 wherein the reference to the template is located within a second template in the grammar.

9. The method of claim 1 wherein the reference to a template is delimited by <templateref> tags.

10. A computer-implemented method comprising:
locating a grammar operator in a grammar that indicates that two items in the grammar are to be combined;
locating the two items in the grammar; and
combining the two items in the grammar to form an output item for a compiled grammar.

11. The method of claim 10 wherein the grammar operator indicates that items in two lists in the grammar are to be pair-wise combined to form an output list of items.

12. The method of claim 11 wherein the grammar operator indicates that each item in the output list of items comprises an item from one list in the grammar concatenated with an item from a second list in the grammar.

13. The method of claim 11 wherein the grammar operator indicates that each item in the output list of items comprises an item from one list in the grammar and a semantic value set equal to an item from a second list in the grammar.

14. The method of claim 10 wherein locating a grammar operator comprises locating tags that delimit items to be combined.

15. A method comprising including a template reference in a first form of a grammar, the template reference identifying a template and a value for a parameter used in the template to identify grammar elements to include in a second form of the grammar.

16. The method of claim 15 wherein identifying a template comprises identifying a template such that a compiler algorithmically generates elements of the second form of the grammar.

17. The method of claim 16 wherein identifying a template comprises identifying a template for an alphanumeric concept and wherein identifying a value for a parameter comprises identifying at least one regular expression to be represented by the grammar elements generated by the compiler.

18. The method of claim 16 wherein identifying a template comprises identifying a cardinal number template and wherein identifying a value for a parameter comprises identifying a set of numbers to be represented by the grammar elements generated by the compiler.

19. The method of claim 16 wherein identifying a template comprises identifying an ordinal number template and wherein identifying a value for a parameter comprises identifying a set of numbers to be represented by the grammar elements generated by the compiler.

20. The method of claim 16 wherein identifying a template comprises identifying a list template and wherein identifying a value for a parameter comprises identifying a set of words to include in a list in the grammar elements generated by the compiler.
